(19) United States
(12) Patent Application Publication
(10) Pub. No.: US 2004/0109913 A1
(43) Pub. Date: Jun. 10, 2004

(54) Shaping Tool for Plastic Housing Parts

(75) Inventor: Guido Drees, Lubbecke (DE)

Correspondence Address: GUDRUN E. HUCKETT, LONSSTR. 53, WUPPERTAL, 42289, DE

(73) Assignee: Balda Werkzeug- und Vorrichtungsbau GmbH, Bad Oeynhausen (DE)

(21) Appl. No.: 10/604,273

(22) Filed: Jul. 8, 2003

(30) Foreign Application Priority Data
Jul. 11, 2002 (DE) 10231551.5

(51) Int. Cl. B29C 45/44

(52) U.S. Cl. 425/556

(57) ABSTRACT

A shaping tool for manufacturing plastic housing parts for electrical devices has a frame and at least one cavity element arranged in the frame. A tool structure is provided on which the frame and the at least one cavity element are connected detachably. Sliding blocks are connected detachably to the tool structure. The frame has several frame parts, wherein a lateral surface of each frame part rests against a longitudinal lateral surface or a transverse lateral surface of the at least one cavity element, respectively. The frame parts and the at least one cavity element have first recesses having sidewalls, wherein the sidewalls rest flat against lateral surfaces of the sliding blocks.

### BACKGROUND OF INVENTION

1. Field of the Invention

The invention relates to a shaping or molding tool for manufacturing plastic housing parts for electrical devices, wherein the shaping tool (molding tool) is comprised of a frame and at least one cavity member arranged within the frame.

The invention also relates to a method for manufacturing a shaping tool for plastic housing parts.

2. Description of the Related Art

For the purpose of manufacturing plastic housing parts for electrical devices, special requirements are to be observed. Since the housing parts are used for expensive technical devices, the housing parts must visually give the appearance of high quality processing standards and must be visually flawless. The electrical or electronic devices usually have several displays and operating function keys for which matching openings must be provided in the plastic housing parts. The openings must be cast with a high degree of precision either because otherwise mounting of the housing parts on the electronic components is impossible or because improper fit impairs proper functioning of the device or reduces the impression of quality. The housing parts have moreover difficult geometries with arched or curved surfaces and undercuts which pose additional requirements with regard to the precision of the manufacturing process.

In order to oblige with the high-quality requirements in regard to the device housing parts, it is known in the prior art to configure one tool for one component, respectively. The tool is manufactured of a single-piece frame into which one or several cavity elements can be mounted. The completed module is then inserted into the injection molding machine and the housing parts are manufactured by injection molding in the machine.

This manufacturing process for the shaping tools has disadvantages. For example, the process for manufacturing the entire shaping tool, i.e., cavity element and frame including the required ejectors and inner and outer slides, requires a great expenditure of time which delays the start of the production process. Moreover, in the case of growing production numbers of the housing parts, the single shaping tool manufactured in this way is not suitable for further use in double cavity, four-fold cavity or other shaping tool configurations. For this purpose, a new manufacturing process is required because the first tool that has been produced cannot be reused at all or a conversion would require significant expenditure. In the case of constructive changes of the housing parts, move of the production sites, and tool change, such conventional shaping tools were found to be difficult and cumbersome to handle. An adaptation or retooling of the conventional tools is possible only with great expenditure. Since the components of the shaping tool cannot be used again or can be reused only in connection with a hardly justifiable economic expenditure, it is necessary to produce a completely new shaping tool at high expenditure when production of a new housing part is to begin or when production is to be increased by means of multiple tools (tools producing several products at once). The system of tool manufacture is therefore overall not flexible enough and too complex.

### SUMMARY OF INVENTION

It is an object of the present invention to reduce the expenditure for manufacturing shaping tools and to increase flexibility with regard to production.

In accordance with the present invention, this is achieved in that the frame and the cavity element are detachably mounted on a tool structure, in that the frame is comprised of several individual frame parts of which a lateral surface rests against the longitudinal or transverse lateral surfaces of the cavity element, respectively, wherein the individual frame parts and the cavity element have recesses whose sidewalls are flatly seated against the lateral surfaces of sliding blocks, which are connected detachably to the tool structure.

According to another embodiment, the cavity element and the individual frame parts of the frame are detachably mounted on the tool structure and the dimensions of the cavity element of the individual frame parts, and of the tool structure are matched to one another such that the cavity element and the individual frame parts can be identically mounted to generate a single, double or quadruple cavity tool or other multiple cavity tool.

According to yet another embodiment, this is achieved in that the structural components of the cavity element, of the tool structure, and of the individual frame parts are detachably connected to one another and in that each structural component, in combination with other structural components having the same structural component-specific shape, can be mounted to generate a new tool.

In connection with the method of the present invention, the object is achieved in that at least one cavity element and individual frame parts of the frame are detachably mounted as individual structural components on the tool structure.

When applying the suggested modular concept for manufacturing the tool, individual cavity elements can be removed from a tool structure and can be used in other tool structures. In this way, it is possible to start production initially with a single cavity element; when production is to be increased because of growing sales of the product, a second cavity element is prepared and both cavity elements are mounted in one shaping tool. The manufacturing time for manufacturing the new tool is extremely short because only the second cavity element must be made. The first cavity element, the individual structural components, and the tool structure are present as elements of a modular system and must not be manufactured separately. In this way, storing capacities for shaping tool blanks and complete parts can be significantly reduced; the retooling expenditure for the shaping tool is significantly reduced when in the case of a change in the shape of the housing part to be produced only a single cavity element must be inserted.

The tool structures and individual structural components of the frame in principle can be reused and accelerate the manufacture of a new tool for new shaped housing parts. In the case of manufacturing housing parts at several production sites, the production processes can be flexibly adjusted to the local production requirements because it is sufficient to exchange only the cavity elements between the individual production sites. In contrast to complete shaping tools, cavity elements can be shipped as packages by express mail or courier. As a result of the high flexibility with respect to the tool, inexpensive manufacturing costs, which are essentially independent of the difficult-to-foresee numbers of pieces to be produced, can be offered to customers who want to manufacture housing parts.

### BRIEF DESCRIPTION OF DRAWINGS

FIG. 1 is a cross-section of a portion of the shaping tool according to the invention.

FIG. 2 is a further cross-section of the shaping tool.

FIG. 3 is a detail view of a cavity element of the shaping tool.

FIG. 4 is a perspective view of the shaping tool at the ejector side.

FIG. 5 is a perspective view of the shaping tool at the hot side.

### DETAILED DESCRIPTION

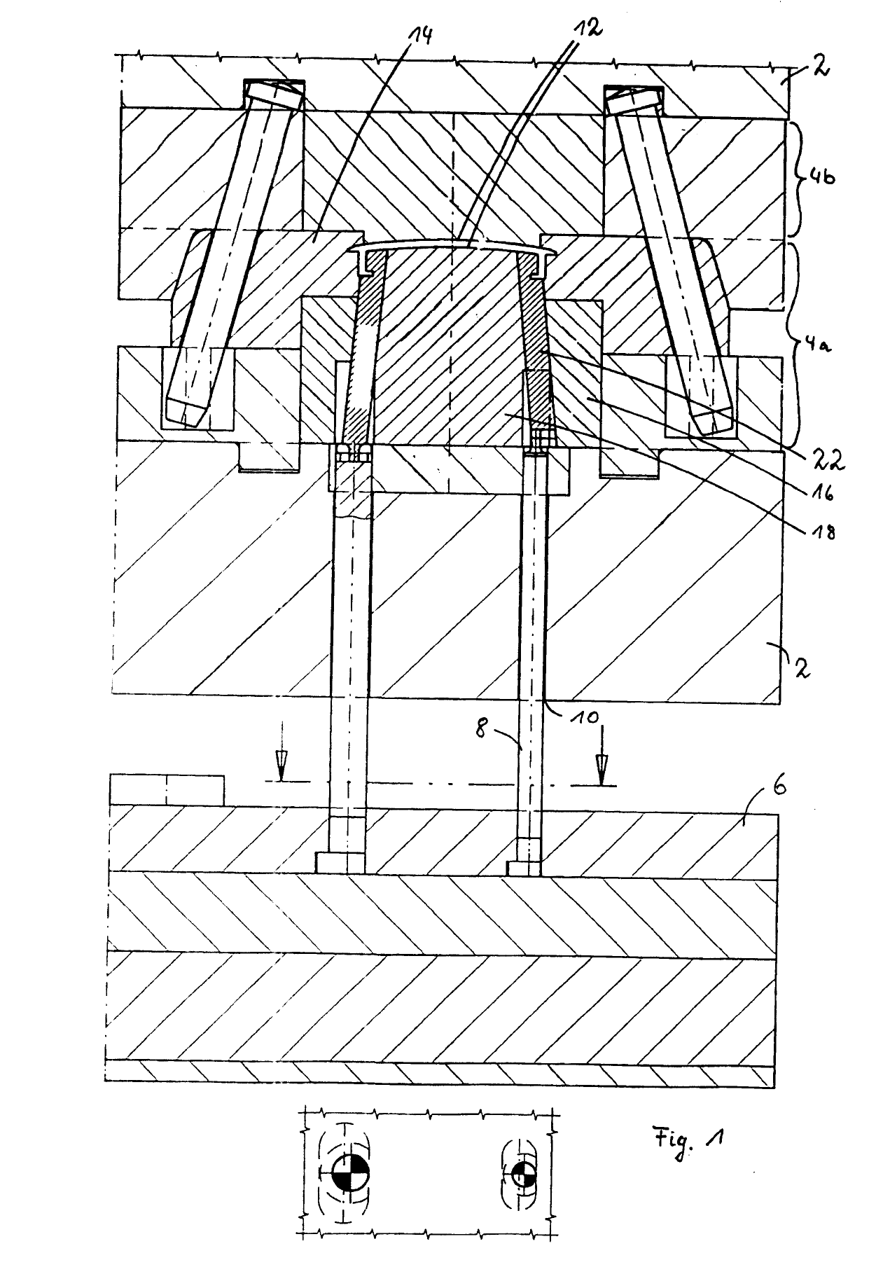

FIG. 1 is a cross-section of a complete shaping tool. A cavity element 4 is mounted on a tool structure 2, i.e., a cavity member 4a is provided on the ejector side and a cavity member 4b is provided on the hot side. The tool structure 2 on the ejector side includes an ejector plate 6 with ejectors 8. The ejector side in this tool structure 2 is provided with channels 10 for the ejectors. The contour-forming shaping surfaces 12 of the cavity members 4a, 4b form between them a hollow space or cavity which must be filled with plastic material for producing plastic housing parts. The complex contour of the housing part with undercut can be easily seen in the FIG. 1. When the injection process is complete, the cavity members 4a, 4b of the cavity element 4 are moved apart. The ejector slide 14 is moved by means of the slantedly positioned guide pins to the exterior. At the same time, the ejectors 8 are moved by the ejector plate 6 into an ejection position where the inner slide 22 finally pivots inwardly and in this way the finished plastic housing part can be removed from the ejectors. The cavity element 4 is essentially formed by the insert 16 into which the core 18 with the contour-forming shaping surface 12 is inserted.

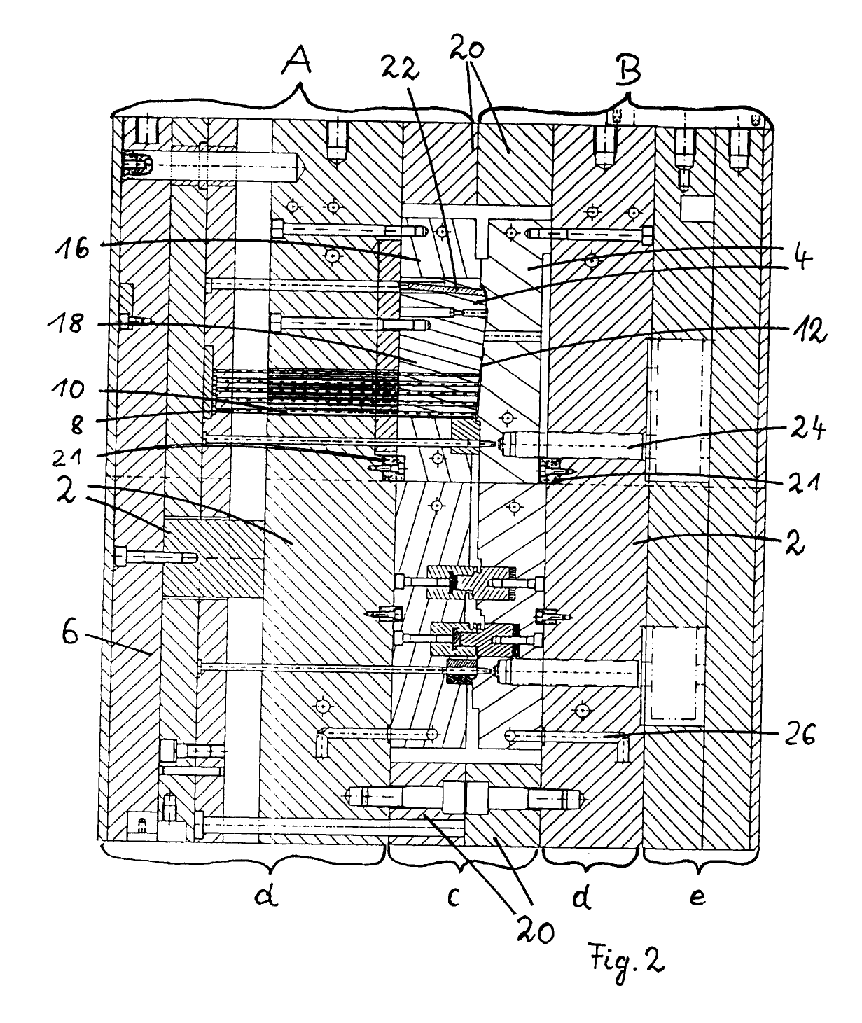

In FIG. 2, a cross-section of a complete shaping tool can be seen. The ejector side A and the hot side B are to be differentiated. When the tool is in the closed position, the structural components of the cavity element and of the individual frame parts 20 are located opposite one another in the area c. The cavity elements 4 and the individual frame parts 20 are fastened on a tool structure 2 arranged in the area d. The hot side B has in addition a hot channel system in the area e. The cavity elements 4 are secured by sliding blocks 21. Instead of sliding blocks 21, one of the components cavity elements 4, individual frame parts 20, and tool structure 2 can have a shaped portion (projection), for example, a cube or a parallelepiped, which projects past the contacting surfaces and is positioned such that, in accordance with the modular concept, it can project into the matching recesses 28 of neighboring components. The arrangement of the ejectors 8 on the ejector plate 6 can be seen very well in the illustration; the ejectors 8 project into the channels 10 provided for the ejectors, respectively. The position of the inner slide 22 is also illustrated.

The heated plastic material is injected through the hot channel 24 into the cavity element formed peripherally by the contour-forming shaping surfaces 12. Moreover, channels 26 for heating/cooling of the tool are illustrated which extend from the tool structure 2 into the cavity element 4.

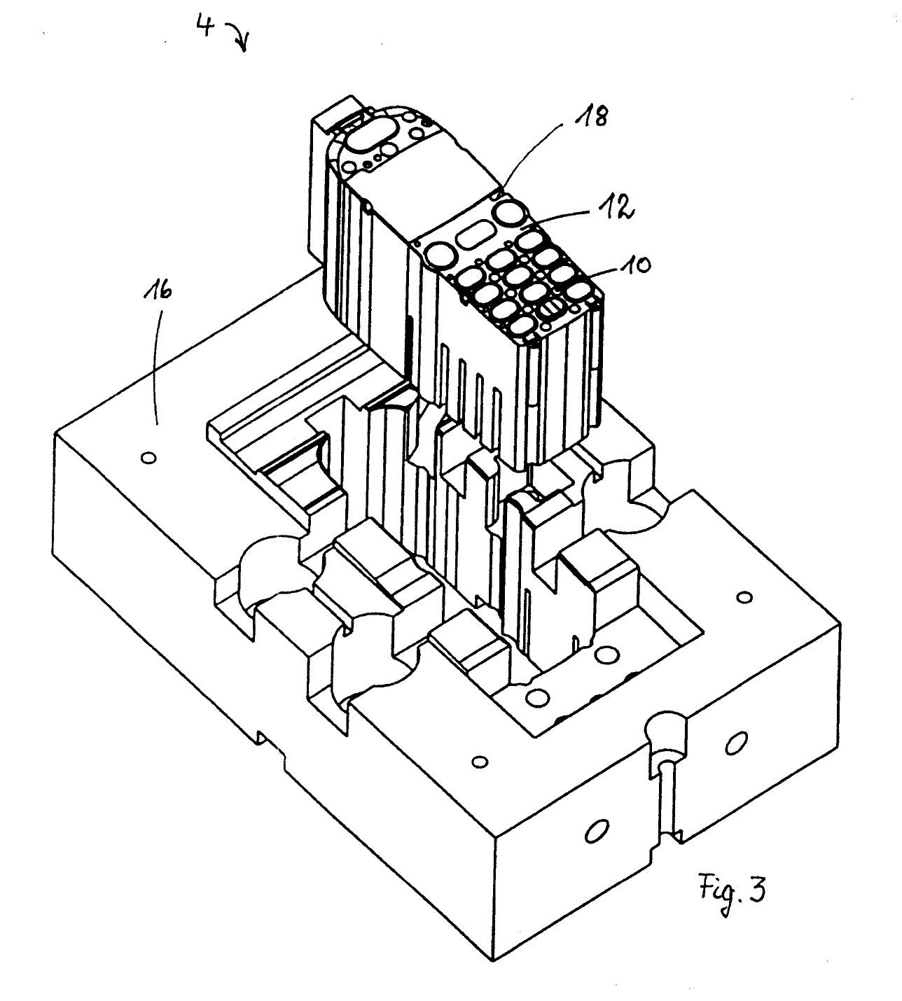

FIG. 3 shows a perspective illustration of a cavity element 4. For reasons of simplification of the drawing, the ejectors 8 and the outer slide 14 are not illustrated. Illustrated are however the channels 10 for the ejectors 8 which open into the contour-forming shaping surfaces 12 and extend into the core 18. The insert 16 has recesses 28 for receiving drive elements for controlling slides.

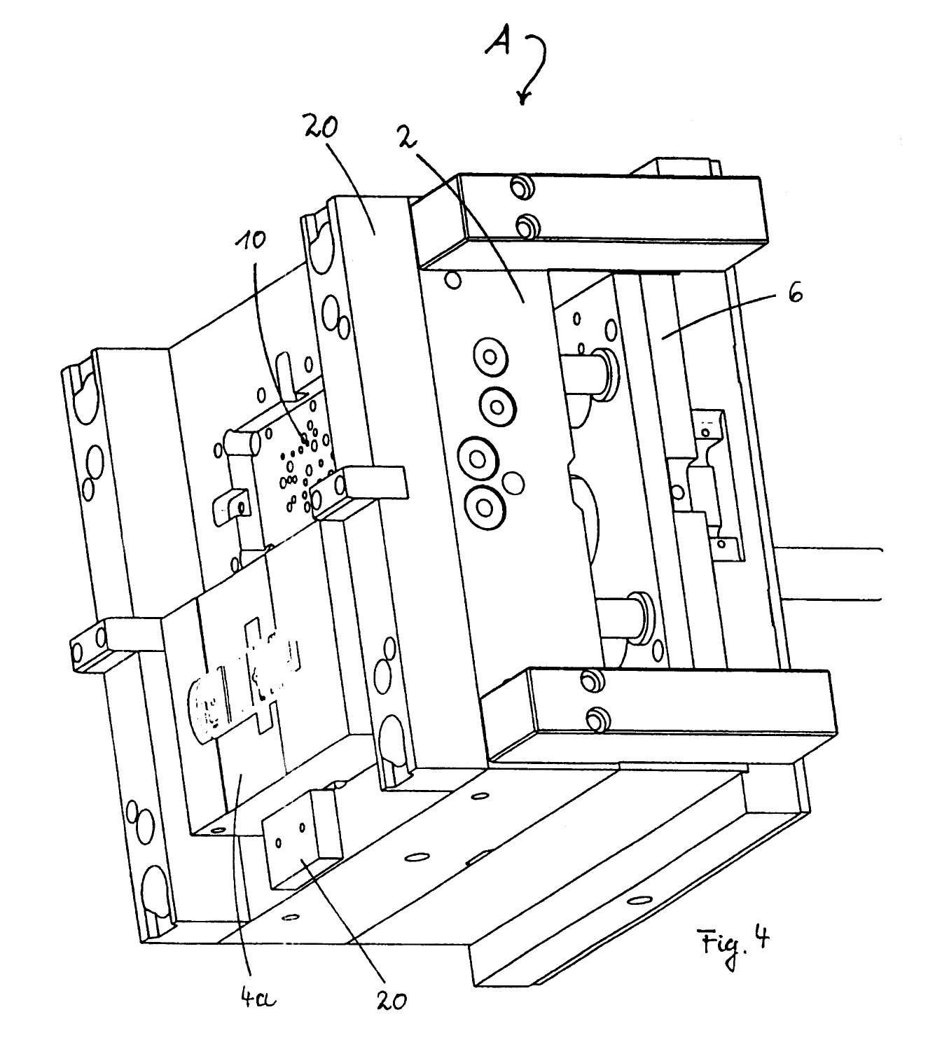

FIG. 4 shows a shaping tool at the ejector side. As an example, the cavity member 4a is illustrated which is attached to the tool structure 2. Adjacent, a recess in the tool structure 2 is illustrated into which an additional cavity member 4a can be inserted. Also visible is the hole pattern of the openings of the channels 10 for the ejectors and those of the cooling or heating channels, inner slide or other elements. The cavity member 4a is secured in its position by laterally adjoining individual frame parts 20 which rest with their lateral surfaces flat against the lateral surfaces of the cavity member 4a. The illustrated double cavity tool can be combined with an identically constructed additional double cavity tool so that a quadruple cavity tool will result.

A detachable cavity member 4a connected to the tool structure 2 can be detached easily from the tool structure and mounted in a different shaping tool which has a hole pattern matching that of the cavity member 4a. The shaping tools configured according to a modular design can also be used as a single cavity shaping tool, a double cavity shaping tool, a quadruple cavity shaping tool in shaping tools for injection molding machines with rotary stack technology, rotary technology or with stack tools. The technology can be used also when a plastic housing part of several plastic materials is to be produced and several injection molding processes are required for manufacturing a finished housing part.

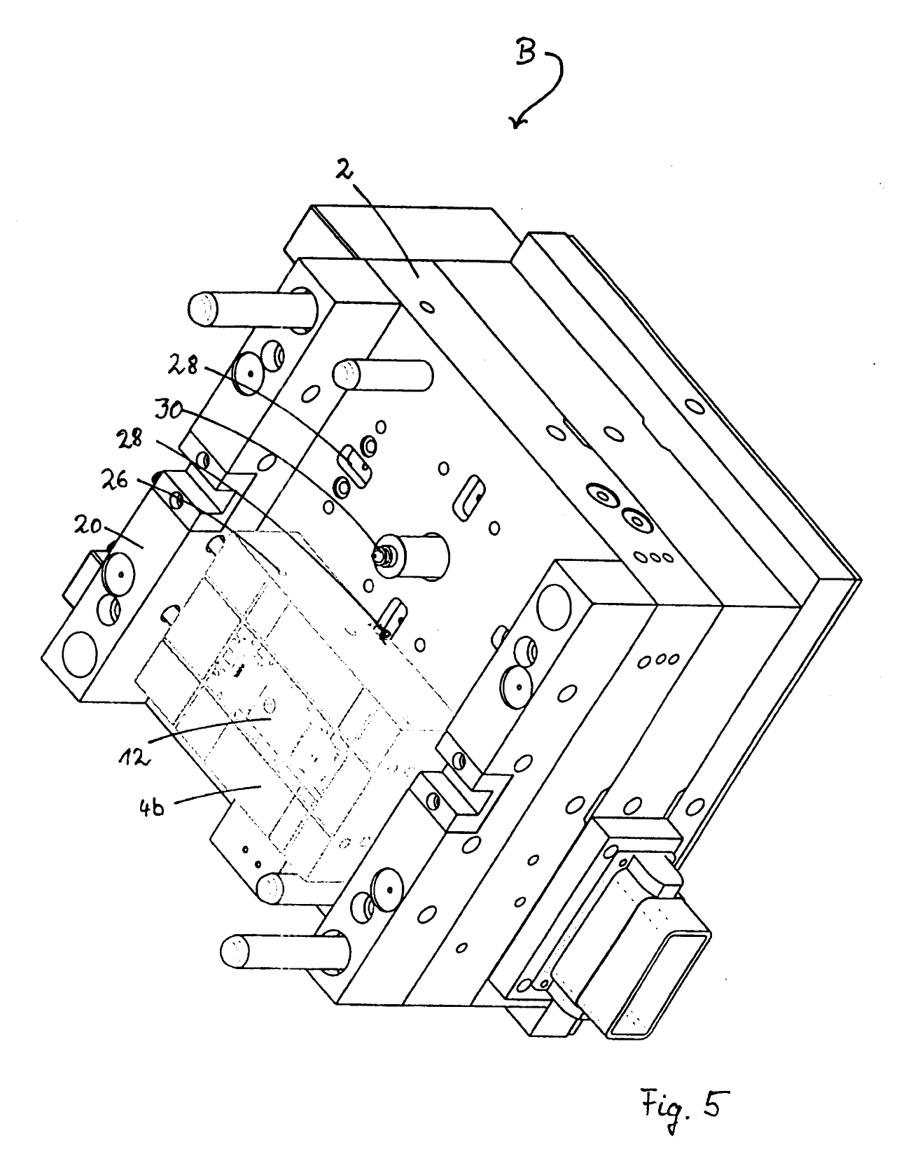

FIG. 5 shows a shaping tool used on the hot side. A nozzle 30, onto which a cavity member 4b must still be placed, is illustrated. On the left side the completed mounting position of the cavity member 4b is illustrated. Als illustrated are the recesses 28 in the surface of the tool structure 2 and on the exterior surface of the cavity member 4b facing the tool structure 2.

The shaping tool according to the invention can be mounted in a simple way. For building a complete tool, it is only necessary that initially one cavity element 4, i.e., its cavity members 4a, 4b, is shaped and hardened. As soon as this structural component is available, the cavity members 4a, 4b must only be screwed onto the desired tool structure 2 or attached in any other suitable way. On the exterior, the cavity elements 4 are delimited by individual frame parts 20 of the frame. The individual frame parts 20 as well as the tool structure 2 can be standardized structural components which are stocked and which can be exchanged easily. The connection between the individual structural components or modules is carried out preferably by screw connections, but any other suitable detachable type of connection can be used.

In the embodiment, the shaping tools are used for manufacturing plastic housing parts for mobile phones. The cavity element sizes are within the range of 130×200 mm to 100×200 mm. For other housing dimensions, the dimensions of the cavity elements can be matched accordingly. The same holds true for positioning the inner and outer slides as well as the ejectors. Since, independent of the manufacturer, the dimensions of typical electronic devices, such as mobile phones, CD players, cordless phones, car stereo devices, watches and clocks, portable computers and similar devices, are often almost identical, the tool structures with the receptacles for the cavity elements with certain dimensions can be reused when new cavity elements are produced in shaping tools for manufacturing housing parts for other devices, in some cases even for different clients. The same holds true for the individual frame parts 20 of the frame which can also be reused.

While specific embodiments of the invention have been shown and described in detail to illustrate the inventive principles, it will be understood that the invention may be embodied otherwise without departing from such principles.

What is claimed is:

1. A shaping tool for manufacturing plastic housing parts for electrical devices, wherein the shaping tool comprises:
a frame;
at least one cavity element arranged in the frame;
a tool structure, wherein the frame and the at least one cavity element are connected detachably to the tool structure;
sliding blocks connected detachably to the tool structure;
wherein the frame is comprised of several frame parts,
wherein a lateral surface of each one of the frame parts rests against a longitudinal lateral surface or a transverse lateral surface of the at least one cavity element, respectively;
wherein the frame parts and the at least one cavity element have first recesses having sidewalls, wherein the sidewalls rest against lateral surfaces of the sliding blocks.

2. The shaping tool according to claim 1, wherein the first recesses in the frame parts and the at least one cavity element are positioned adjacent to one another such that neighboring ones of the recesses receive a common one of the sliding blocks.

3. The shaping tool according to claim 1, wherein the tool structure has second recesses, wherein the sliding blocks are secured in the second recesses of the tool structure, and wherein the second recesses have lateral surfaces resting flat against the lateral surfaces of the sliding blocks.

4. The shaping tool according to claim 3, wherein the second recesses in the tool structure are positioned such that the sliding blocks secured in the second recesses projects with a lateral surfaces into one of the first recesses, respectively.

5. The shaping tool according to claim 1, wherein at least one structural component selected from the at least one cavity element, the frame part, and the tool structure has a projection projecting past planar contact surfaces of the at least one structural component and having surfaces projecting into the first recess or the second recess of a neighboring one of the structural components, wherein the surfaces of the projection rest flat against surfaces of the first recess or the second recesses of the neighboring structural component.

6. The shaping tool according to claim 1, wherein at least one of the sliding blocks and the first and second recesses have hardened surfaces.

7. The shaping tool according to claim 1, wherein the individual frame parts are detachably connected to the tool structure, wherein the size of the at least one cavity element, of the frame parts, and of the tool structure are matched to one another such that the at least one cavity element and the frame parts are combinable as a single cavity shaping tool, a double cavity shaping tool, a quadruple cavity shaping tool, or multiple cavity shaping tool.

8. The shaping tool according to claim 7, wherein the lateral surfaces of the frame parts have a frame part length matching a length of the longitudinal lateral surface of the at least one cavity element, when the lateral surfaces of the frame part are arranged on the longitudinal lateral surface of the at least one cavity element, or matching a width of the at least one cavity element, when the lateral surfaces are arranged on the transverse lateral surface of the at least one cavity element.

9. The shaping tool according to claim 7, wherein hole patterns of the at least one cavity element, the frame parts, and the tool structure of openings receiving injectors, nozzles, slides, and heating or cooling channels match one another at contacting surfaces of the at least one cavity element, the frame parts, and the tool structure.

10. The shaping tool according to claim 7, wherein several exchangeable cavity elements are provided, wherein hole patterns of the cavity elements and of the tool structure of openings receiving injectors, nozzles, slides, and heating or cooling channels match one another at contacting surfaces of the cavity elements and of the tool structure, wherein, when a first one of the cavity elements is removed from the tool structure, a second one of the cavity elements is detachably mounted on the tool structure.

11. The shaping tool according to claim 10, wherein the exchangeable cavities have different cores.

12. The shaping tool according to claim 10, wherein the exchangeable cavities have identical cores.

13. The shaping tool according to claim 1, wherein structural components of the at least one cavity element, of the tool structure, and of the frame parts are detachably connected with one another, and wherein each one of the structural components in combination with other structural components having an identical structural component-specific shape can be combined and connected to form a new shaping tool.

14. The shaping tool according to claim 1, wherein the shaping tool has an ejector side substantially comprised of the at least one cavity element, the frame parts of the frame, and the tool structure, wherein the at least one cavity element has a contour-forming shaping surface, openings for ejectors and ejector slides as well as channel bores for a heating liquid or a cooling liquid, wherein the frame parts of the frame have contact surfaces for contacting individual structural components of the at least one cavity element, wherein the tool structure has devices at the ejector side for attaching the at least one cavity element and the frame parts and further has a hole pattern enabling penetration of the ejector slide and the ejectors into the at least one cavity element.

15. The shaping tool according to claim 14, wherein the shaping tool has a hot side substantially formed by the at least one cavity element, the frame parts of the frame, and the tool structure, wherein the at least one cavity element has a contour-forming shaping surface, opening for the ejector slides, nozzles, and channel bores for the heating liquid or the cooling liquid, wherein the frame parts of the frame have contact surfaces for contacting individual structural components of the at least one cavity element, and wherein the tool structure has devices at the hot side for attaching the at least one cavity element and the frame parts and further has a hole pattern enabling penetration of the nozzles into the at least one cavity element.

16. The shaping tool according to claim 15, wherein the shaping tool comprises of a shaping tool part on the ejector side and a shaping tool part on the hot side.

17. A method for manufacturing a shaping tool according to claim 1, comprising the step of:
providing a tool structure;
providing a frame comprised of individual frame parts;
providing at least one cavity element;
detachably mounting the at least one cavity element and the individual frame parts as individual structural components on the tool structure.
